(19) United States
(12) Patent Application Publication
(10) Pub. No.: US 2024/0094336 A1
(43) Pub. Date: Mar. 21, 2024

(54) AFFINE FREQUENCY DIVISION MULTIPLEXING WAVEFORMS FOR DOUBLY DISPERSIVE CHANNELS

(71) Applicant: HUAWEI TECHNOLOGIES CO., LTD., Shenzhen (CN)

(72) Inventors: Nassar KSAIRI, Boulogne Billancourt (FR); Merouane DEBBAH, Boulogne Billancourt (FR)

(21) Appl. No.: 18/516,515

(22) Filed: Nov. 21, 2023

Related U.S. Application Data
(63) Continuation of application No. PCT/EP2021/063579, filed on May 21, 2021.

(51) Int. Cl. G01S 7/288; G01S 7/292

(52) U.S. Cl. CPC G01S 7/2883; G01S 7/292

(57) ABSTRACT

A signal may be generated by modulating a plurality of chirp signals with a set of input symbols. Chirp signals may be characterized by a second order bivariate polynomial and the coefficients of the quadratic terms of the polynomial may be selected to achieve desired frequency diversity. Furthermore, at least one of the coefficients may be adjusted based on channel state information to mitigate effective Doppler spread in a discrete affine Fourier transform domain virtual channel.

### CROSS-REFERENCE TO RELATED APPLICATIONS

This application is a continuation of International Application PCT/EP2021/063579, filed on May 21, 2021, the disclosure of which is hereby incorporated by reference in its entirety.

### BACKGROUND

In wireless communications, signals may be transmitted to, or between, mobile devices that are not stationary. In high-mobility scenarios, e.g., in cases where either the transmitting device or the receiving terminal or both are moving rapidly with respect to each other, transmitted signals are received in a corrupted state with large values of Doppler frequency shift. Moreover, the different contributions in the received signal originating from different reflecting and scattering objects in the environment may be received with different values of the Doppler frequency shift. The time between reception of the first and last of these different signal paths may be called the delay spread. The difference between the smallest and the largest Doppler shift in the received signal may be called the Doppler frequency spread. Such wireless channels may be referred to as doubly dispersive, because they involve both dispersion in time, due to the delay spread, and in frequency, due to the Doppler spread. The larger the Doppler spread, the more difficult is the challenge posed to data detection at the receiving terminals.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective of the present disclosure to provide a device and a method for generating affine frequency division multiplexing (AFDM) signals that improve diversity and robustness. The foregoing and other objectives may be achieved by the features of the independent claims. Further implementation forms are apparent from the dependent claims, the description, and the drawings.

According to a first aspect, a device for generating a signal is provided. The device may be configured to obtain a set of input symbols and modulate a plurality of chirp signals, w[m, n], based on the set of input symbols. The plurality of chirp signals, w[m, n], may be based on a bivariate polynomial, p(m, n), of input symbol index m and chirp signal time index n. The bivariate polynomial, p(m, n), may comprise a first coefficient, c₁, of a quadratic term of the chirp signal time index n and a second coefficient, c₂, of a quadratic term of the input symbol index m. The first coefficient, c₁, may comprise a sum of a system parameter, c_{1,0}, and a channel parameter, ε₁. This solution improves the transmission performance in a time-frequency selective transmission channel by improving frequency diversity and mitigating impairments caused by the transmission channel.

According to an implementation form of the first aspect, the system parameter, c_{1,0}, and the second coefficient, c₂, may be configured to cause a predetermined frequency sweep range for the plurality of chirp signals, w[m, n]. The device may be further configured to determine the channel parameter, ε₁, based on channel state information of a transmission channel. This solution enables to control frequency diversity by adjusting the frequency sweep range of the chirp signals and to mitigate impairments in particular channel conditions.

According to an implementation form of the first aspect, the channel state information may comprise a delay-Doppler profile of the transmission channel. This solution enables to mitigate impairments due to the mobility of the transmitter and/or the receiver.

According to an implementation form of the first aspect, the channel state information may comprise an estimated impulse response of the transmission channel. The device may be further configured to transform the estimated impulse response of the transmission channel to an affine Fourier transform domain characterized by the first coefficient, c₁, and the second coefficient, c₂, to obtain a virtual impulse response of the transmission channel and determine the channel parameter, ε₁, such that a mean or a weighted mean of Doppler shifts of paths of the virtual impulse response of the transmission channel is smaller than a mean or a weighted mean of Doppler shifts of paths of the estimated impulse response of the transmission channel. This solution enables to mitigate impairments due to mobility in affine frequency division multiplexing (AFDM) communications.

According to an implementation form of the first aspect, the system parameter, c_{1,0}, and the second coefficient, c₂, may be inversely proportional to N, wherein N is a maximum number of the plurality of chirp signals, w[m, n]. This solution improves frequency diversity by increasing the frequency sweep range of the chirp signals.

According to an implementation form of the first aspect, the plurality of chirp signals, w[m, n], may be based on

$$w [ m , n ] = \frac{1}{\sqrt{N}} {e}^{- j \frac{2 π}{N} p ( m , n )} ,$$

$$where p ( m , n ) = {c}_{1} {n}^{2} + {c}_{2} {m}^{2} - \frac{n m}{N} ,$$

$$where {c}_{1} = {c}_{1 , 0} + {ε}_{1} , {c}_{1 , 0} = \frac{∓ 1}{2 N} , {c}_{2} = \frac{∓ 1}{2 N} ,$$

and wherein N is a maximum number of the plurality of chirp signals, w[m, n]. This solution improves frequency diversity by causing each chirp signal to sweep over substantially whole signal bandwidth and further enables to mitigate impairments in particular channel conditions.

According to an implementation form of the first aspect, the device may be further configured to: receive U sets of Nᵤ input symbols for a set of U users, where u∈{1, . . . , U}, wherein U≥1; divide each of the U sets of Nᵤ input symbols into Cᵤ symbol blocks, wherein Cᵤ≥1; apply a precoder for each of the Cᵤ symbol blocks; insert a prefix and a suffix for each of the precoded Cᵤ symbol blocks; and apply an N-point inverse discrete affine Fourier transform characterized by the first coefficient, c₁, and the second coefficient, c₂, to an aggregation of the U sets of Nᵤ input symbols, wherein N is a maximum number of the plurality of chirp signals, w[m, n]. This solution enables to multiplex a plurality of users in the generated AFDM signal in order to simultaneously improve transmission performance for multiple users.

According to an implementation form of the first aspect, the precoder may comprise an

$$⌈ \frac{{N}_{u}}{{C}_{u}} ⌉$$

-point inverse discrete Fourier transform. This solution provides a low-complexity implementation for generating the AFDM signal and thereby to improve transmission performance in a time-frequency selective transmission channel.

According to an implementation form of the first aspect, the precoder may comprise an Nᵤ-point inverse discrete affine Fourier transform characterized by a first user-specific coefficient, c_{u,1}, and a second user-specific coefficient, c_{u,2}, wherein the first user-specific coefficient comprises a sum of a user-specific system parameter, c_{u,1,0}, and a user-specific channel parameter, ε_{u,1}. The precoder may further comprise an Nᵤ-point discrete affine Fourier transform (318) characterized by the system parameter, c_{1,0}, and the second coefficient, c₂. This solution enables to control frequency diversity and mitigate impairments caused by the transmission channel separately for each user and thereby to optimize transmission performance for each user.

According to an implementation form of the first aspect, the device may be further configured to determine the user-specific channel parameter, ε_{u,1}, based on channel state information of user u. This solution enables to mitigate impairments caused by the transmission channel separately for each user in particular channel conditions.

According to an implementation form of the first aspect, the channel parameter, ε₁, may be equal to zero. This solution enables a fully user-specific adaptation of the channel parameters to mitigate impairments of the transmission channel.

According to an implementation form of the first aspect, the device may be further configured to determine the channel parameter, ε₁, based on the channel state information. The channel state information may comprise an aggregation of channel state information of the set of U users u∈{1, . . . , U}. This solution enables to mitigate impairments of the transmission channel simultaneously for a plurality of users.

According to an implementation form of the first aspect, the prefix may comprise a cyclic prefix and the suffix may comprise a cyclic suffix. Alternatively, the prefix may comprise a zero-valued prefix and the suffix may comprise a zero-valued suffix. This solution enables to avoid interference between multiple users and to perform simple one-tap equalization based on the samples received in the discrete affine Fourier transform (DAFT) domain.

According to an implementation form of the first aspect, the device may be further configured to determine a length of the prefix or a length of the suffix as a function of the first coefficient, c₁, the second coefficient, c₂, and the channel state information of user u. This solution enables to select the length of the prefix and the suffix such that sufficient protection against interference is provided without unnecessary overhead.

According to an implementation form of the first aspect, the device may be further configured to insert a plurality of pilot symbols within at least one of the Cᵤ symbol blocks according to at least one pilot pattern. This solution enables channel estimation after inverse precoder at a receiver and to use pilot patterns similar to pilot patterns of orthogonal frequency division multiplexing (OFDM) systems.

According to an implementation form of the first aspect, the device may be further configured to insert the plurality of pilot symbols at at least one edge of at least one of the precoded Cᵤ symbol blocks. This solution enables channel estimation before inverse precoder at a receiver and a lower pilot overhead for multiple-input multiple-output (MIMO) schemes.

According to an implementation form of the first aspect, the device may be further configured to insert a plurality of guard symbols adjacent to the plurality of pilot symbols or adjacent to at least one of the plurality of pilot symbols. This solution enables to avoid interference between pilot symbols and data symbols and thereby to improve reliability of both channel estimation and data detection.

According to an implementation form of the first aspect, the device may be further configured to transmit the signal. The device may be further configured to transmit an indication of at least one of: the first user-specific coefficient, c_{u,1}, the second user-specific coefficient, c_{u,2}, the user-specific system parameter, c_{u,1,0}, or the user-specific channel parameter, ε_{u,1}. This solution enables to dynamically adapt the user-specific DAFT parameters to optimize transmission for current channel conditions and requirements of each user.

According to an implementation form of the first aspect, the device may be further configured to transmit the signal. The device may be further configured to transmit an indication of at least one of: the first coefficient, c₁, the system parameter, c_{1,0}, the channel parameter, ε₁, or the second coefficient, c₂. This solution enables to dynamically adapt the DAFT parameters to optimize transmission for current channel conditions and requirements.

According to a second aspect, a device for receiving a signal is provided. The device may be configured to demodulate the signal, wherein the signal comprises a plurality of chirp signals, w[m,n], modulated based on a set of input symbols. The plurality of chirp signals, w[m, n], may be based on a bivariate polynomial, p(m, n), of input symbol index m and chirp signal time index n. The bivariate polynomial, p(m, n), may comprise a first coefficient, c₁, of a quadratic term of the chirp signal time index n and a second coefficient, c₂, of a quadratic term of the input symbol index m. The first coefficient, c₁, may comprise a sum of a system parameter, c_{1,0}, and a channel parameter, ε₁. This solution improves the reception performance in a time-frequency selective transmission channel by improving frequency diversity and mitigating impairments caused by the transmission channel.

According to an implementation form of the second aspect, the system parameter, c_{1,0}, and the second coefficient, c₂, may be configured to cause a predetermined frequency sweep range for the plurality of chirp signals, w[m, n]. The channel parameter, ε₁, may be dependent on channel state information of a transmission channel. This solution enables to receive signals with an adjustable frequency sweep range of the chirp signals and configured to mitigate impairments in particular channel conditions.

According to an implementation form of the second aspect, the channel state information may comprise a delay-Doppler profile of the transmission channel. This solution enables to receive signals configured to mitigate impairments due to mobility of the transmitter and/or the receiver.

According to an implementation form of the second aspect, the system parameter, c_{1,0}, and the second coefficient, c₂, may be inversely proportional to N, wherein N is a maximum number of the plurality of chirp signals, w[m, n]. This solution improves frequency diversity by increasing the frequency sweep range of the chirp signals.

According to an implementation form of the second aspect, the plurality of chirp signals, w[m, n], may be based on

$$w [ m , n ] = \frac{1}{\sqrt{N}} {e}^{- j \frac{2 π}{N} p ( m , n )} ,$$

$$where p ( m , n ) = {c}_{1} {n}^{2} + {c}_{2} {m}^{2} - \frac{n m}{N} ,$$

$$where {c}_{1} = {c}_{1 , 0} + {ε}_{1} , {c}_{1 , 0} = \frac{∓ 1}{2 N} , {c}_{2} = \frac{∓ 1}{2 N} ,$$

and wherein N is a maximum number of the plurality of chirp signals, w[m, n]. This solution improves frequency diversity by causing each chirp signal to sweep over substantially whole signal bandwidth and to mitigate impairments in particular channel conditions.

According to an implementation form of the second aspect, the device may be further configured to: apply an N-point discrete affine Fourier transform characterized by the first coefficient, c₁, and the second coefficient, c₂, to the signal, wherein the signal comprises U sets of Nᵤ modulated input symbols for a set of U users, where u∈{1, . . . , U}, wherein U≥1, wherein each of the U sets of Nᵤ input symbols is divided into Cᵤ symbol blocks, wherein Cᵤ≥1, and wherein N is a maximum number of the plurality of chirp signals, w[m, n]; eliminate a prefix and a suffix of at least one of the Cᵤ symbol blocks; and apply an inverse precoder for the at least one of the Cᵤ symbol blocks. This solution enables to demodulate AFDM data from a multi-user signal with improved reception performance.

According to an implementation form of the second aspect, the inverse precoder may comprise an

$$⌈ \frac{{N}_{u}}{{C}_{u}} ⌉$$

-point discrete Fourier transform. This solution provides a low-complexity implementation for receiving the AFDM signal to improve reception performance in a time-frequency selective transmission channel.

According to an implementation form of the second aspect, the inverse precoder may comprise an Nᵤ-point inverse discrete affine Fourier transform characterized by the system parameter, c_{1,0}, and the second coefficient, c₂. The inverse precoder may further comprise an Nᵤ-point discrete affine Fourier transform characterized by a first user-specific coefficient, c_{u,1}, and a second user-specific coefficient, c_{u,2}. The first user-specific coefficient, c_{u,1}, may comprise a sum of a user-specific system parameter, c_{u,1,0}, and a user-specific channel parameter, ε_{u,1}. This solution enables to receive an AFDM signal with user-specific frequency diversity and where impairments caused by the transmission channel have been separately mitigated for each user to optimize reception performance for each user.

According to an implementation form of the second aspect, the user-specific channel parameter, ε_{u,1}, may be dependent on channel state information of user u. This solution enables to receive AFDM signals where impairments caused the transmission channel have been mitigated separately for each user in particular channel conditions.

According to an implementation form of the second aspect, the channel parameter, ε₁, may be equal to zero. This solution enables to receive AFDM signals with a fully user-specific adaptation of the channel parameter to mitigate impairments of the transmission channel.

According to an implementation form of the second aspect, the prefix may comprise a cyclic prefix and the suffix may comprise a cyclic suffix. The device may be further configured to eliminate the cyclic prefix and the cyclic suffix by removing symbols of the cyclic prefix and the cyclic suffix. This solution enables to avoid multi-user interference (MUI) and to perform simple one-tap equalization in the DAFT domain.

According to an implementation form of the second aspect, the prefix may comprise a zero-valued prefix and the suffix may comprise a zero-valued suffix, The device may be further configured to eliminate the zero-valued prefix and the zero-valued suffix based on performance of an overlap and add algorithm for the at least one of the Cᵤ symbol blocks. This solution enables to avoid multi-user interference (MUI) and to perform simple one-tap equalization in the DAFT domain. Further, this solution enables to use zero-valued prefix and suffix, which reduces complexity at the transmitter.

According to an implementation form of the second aspect, the device may be further configured to determine a channel estimate based on a plurality of pilot symbols included at at least one edge of the at least one of the Cᵤ symbol blocks. This solution enables channel estimation before inverse precoding.

According to an implementation form of the second aspect, the device may be further configured to determine the channel estimate based on a plurality of pilot symbols included within the at least one of the inverse precoded Cᵤ symbol blocks. This solution enables channel estimation after inverse precoding.

According to an implementation form of the second aspect, the device may be further configured to eliminate a plurality of guard symbols located adjacent to the plurality of pilot symbols or adjacent to at least one of the plurality of pilot symbols. This solution enables to avoid interference between pilot symbols and data symbols and thereby to improve reliability of channel estimation.

According to an implementation form of the second aspect, the device may be further configured to receive the signal. The device may be further configured to receive an indication of at least one of: the first user-specific coefficient, c_{u,1}, the second user-specific coefficient, c_{u,2}, the user-specific system parameter, c_{u,1,0}, or the user-specific channel parameter, ε_{u,1}. This solution enables to dynamically adapt the user-specific DAFT parameters to optimize transmission for current channel conditions and requirements of each user.

According to an implementation form of the second aspect, the device may be further configured to receive the signal. The device may be further configured to receive an indication of at least one of the first coefficient, c₁, the system parameter, c_{1,0}, the channel parameter, ε₁, or the second coefficient, c₂. This solution enables to dynamically adapt the DAFT parameters to optimize transmission for current channel conditions and requirements.

According to a third aspect, a method for generating a signal is provided. The method may comprise obtaining a set of input symbols; and modulating a plurality of chirp signals, w[m, n], based on the set of input symbols. The plurality of chirp signals, w[m, n], may be based on a bivariate polynomial, p(m, n), of input symbol index m and chirp signal time index n. The bivariate polynomial, p(m, n), may comprise a first coefficient, c₁, of a quadratic term of the chirp signal time index n and a second coefficient, c₂, of a quadratic term of the input symbol index m. The first coefficient, c₁, may comprise a sum of a system parameter, c_{1,0}, and a channel parameter, ε₁.

According to a fourth aspect, a method for receiving a signal is disclosed. The method may comprise demodulating the signal, wherein the signal comprises a plurality of chirp signals, w[m,n], modulated based on a set of input symbols. The plurality of chirp signals, w[m, n], may be based on a bivariate polynomial, p(m, n), of input symbol index m and chirp signal time index n . The bivariate polynomial, p(m, n), may comprise a first coefficient, c₁, of a quadratic term of the chirp signal time index n and a second coefficient, c₂, of a quadratic term of the input symbol index m. The first coefficient, c₁, may comprise a sum of a system parameter, c_{1,0}, and a channel parameter, ε₁.

According to a fifth aspect, a computer program is provided. The computer program may comprise program code configured to cause performance of any implementation form of the method of the third aspect, when the computer program is executed on a computer.

According to a sixth aspect, a computer program is provided. The computer program may comprise program code configured to cause performance of any implementation form of the method of the fourth aspect, when the computer program is executed on a computer.

Implementation forms of the present disclosure can thus provide devices, methods, and computer programs for generating or receiving a chirp waveform. These and other aspects of the present disclosure will be apparent from the example embodiment(s) described below.

### DESCRIPTION OF THE DRAWINGS

The accompanying drawings, which are included to provide a further understanding of the example embodiments and constitute a part of this specification, illustrate example embodiments and, together with the description, help to explain the example embodiments. In the drawings:

FIG. 1 illustrates an example of a communication system, according to an embodiment of the disclosure;

FIG. 2 illustrates an example of a device configured to practice one or more embodiments of the disclosure;

FIG. 3 illustrates an example of a system for generating multi-chirp signals, according to an embodiment of the disclosure;

FIG. 4 illustrates an example of a system for receiving multi-chirp signals, according to an embodiment of the disclosure;

FIG. 5 illustrates an example of a system with an inverse discrete Fourier transform (IDFT) based precoder for generating multi-chirp signals, according to an embodiment of the disclosure;

FIG. 6 illustrates an example of a system with a discrete Fourier transform (DFT) based inverse precoder for receiving multi-chirp signals, according to an embodiment of the disclosure;

FIG. 7 illustrates an example of a system with an inverse discrete affine Fourier transform (IDAFT) and discrete affine Fourier transform (DAFT) based precoder for generating multi-chirp signals, according to an embodiment of the disclosure;

FIG. 8 illustrates an example of a system with an IDAFT and DAFT based inverse precoder for receiving multi-chirp signals, according to an embodiment of the disclosure;

FIG. 9 illustrates an example of a method for generating a signal, according to an embodiment of the disclosure; and

FIG. 10 illustrates an example of a method for receiving a signal, according to an embodiment of the disclosure.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present embodiments and is not intended to represent the only forms in which the present examples may be constructed or utilized. The description sets forth the functions of the examples and the sequence of operations for constructing and operating the examples. However, the same or equivalent functions and sequences may be accomplished by different examples.

Next-generation wireless systems are expected to operate on many frequency bands, including bands centered around very high-frequency carriers. Wireless signals transmitted on such channels are prone to impairments, such as carrier frequency offset (CFO) and phase noise (PN) that could degrade the quality of service of data transmission. Currently available waveforms may not provide sufficient tolerance to such mobility and high-frequency impairments. For example, it may be possible to tune waveforms to compensate for these effects, e.g., by making the symbol shorter in OFDM (orthogonal frequency division multiplexing), but such compensation may cause losses in spectral efficiency, as in the example of OFDM, or in other performance metrics. It is thus beneficial to design new waveforms that improve the transmission performance, in terms of reliability, achievable data rate, and/or latency, on channels with large Doppler frequency spread, CFO, and/or PN intensity values. This is an objective of the disclosed transceiver design, namely the affine frequency division multiplexing (AFDM).

AFDM is based on the discrete affine Fourier transform (DAFT) which can be used to generate multi-chirp signals characterized with a number of tunable parameters. The disclosed AFDM waveforms support multiple access, i.e., simultaneous transmission to/from multiple users, and provide both high diversity gain on doubly dispersive channels and low-complexity detection. AFDM is therefore beneficial both in terms of diversity order on doubly dispersive channels and robustness in presence of high-frequency impairments, while being fully compatible with low-complexity detection and with multiple access.

According to an embodiment, a signal may be generated by modulating a plurality of chirp signals with a set of input symbols. A chirp signal may comprise a complex exponential function whose frequency changes with respect to time. The chirp signal may be characterized by a second order bivariate polynomial and the coefficients of the quadratic terms of the polynomial may be selected to achieve desired frequency diversity. Furthermore, at least one of the coefficients may be adjusted based on channel state information to mitigate effective Doppler spread in a DAFT domain virtual channel. For example, the chirp signals may be based on a bivariate polynomial, p(m, n), of input symbol index m and chirp signal time index n. The bivariate polynomial, p(m, n), may comprise a first coefficient, c₁, of a quadratic term of the chirp signal time index n and a second coefficient, c₂, of a quadratic term of the input symbol index m. The first coefficient, c₁, may comprise a sum of a system parameter, c_{1,0}, and a channel parameter, ε₁. Various methods for determining the coefficients are disclosed below.

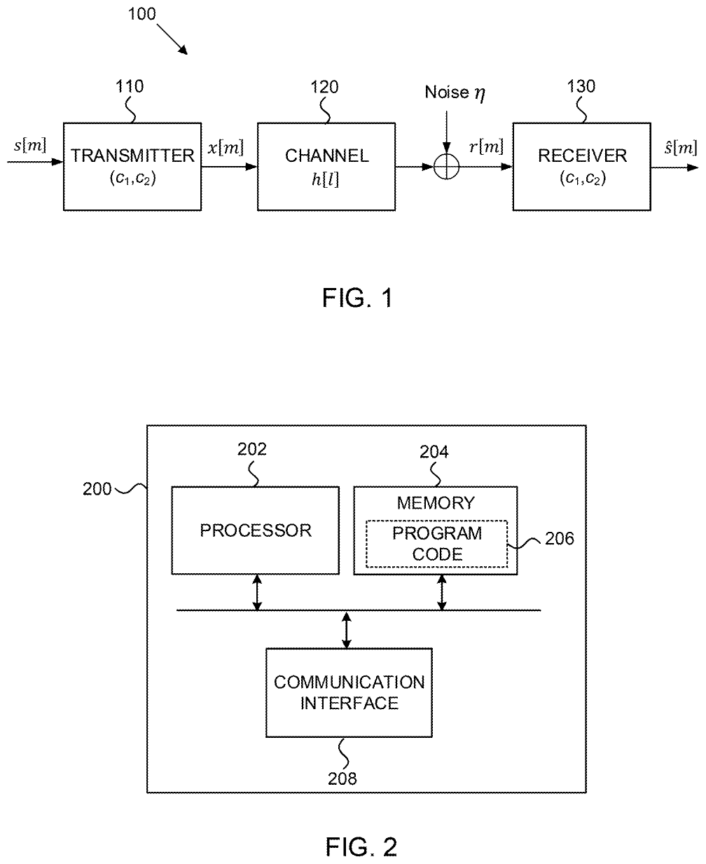

FIG. 1 illustrates an example of a communication system 100, according to an embodiment. The communication system 100 may comprise a transmitter 110, a transmission channel 120, and a receiver 130. The transmitter 110 generates a transmitted signal, x[m], based on a set of input symbols, s[m]. The transmitter 110 may generate a multi-chirp signal characterized by IDAFT coefficients, (c₁, c₂), that can be set with respect to some performance criterion. The coefficients, (c₁, c₂), may be generally understood as IDAFT (or DAFT) parameters. For example, these coefficients may be selected such that a frequency sweep range of each chirp signal is large enough to provide sufficient frequency diversity and such that performance degradation due to Doppler spread is mitigated, as will be further discussed below.

The transmitted signal, x[m], is fed through the transmission channel 120, which may be modeled by an impulse response, h[l]. The impulse response, h[l], may comprise L paths, l∈{1, . . . , L}. Each of the L paths may be associated with a delay, τₗ, and a Doppler frequency shift, vₗ. Such channel may be called doubly-dispersive. A delay-Doppler profile of the transmission channel 120 may comprise the delays and Doppler shifts of the different paths of the channel impulse response, h[l]. Noise may be modeled by adding additive white Gaussian noise, η, after the transmission channel 120. Receiver 130 may determine estimates of the input symbols, ŝ[m], based on received signal, r[m].

A discrete-time waveform of an AFDM signal may be expressed as

$$x [ n ] = {\sum }_{m = 0}^{N - 1} s [ m ] w [ m , n ]$$

for n=0, 1, . . . , N−1, where the input symbols, s[m], are taken from a set of (real or complex-valued) input symbols, and where N is a maximum number of chirp signals, for example an upper limit for modulated orthogonal chirp signals. The chirp signals, w[m, n], may comprise or be based on a term

$${e}^{- j \frac{2 π}{N} p ( m , n )} ,$$

where j=\sqrt{−1} and wherein e is the Euler's number e≈2.71828. The chirp signals may be characterized by a bivariate polynomial, p(m, n), of input symbol index m and chirp signal time index n. Polynomial p(m, n) may comprise a bivariate quadratic polynomial, i.e., bivariate polynomial of a second degree. The time-discrete signal x[n] may be obtained by sampling a corresponding time-continuous signal x(t)=Σₘ₌₀^{N-1}s[m]w(m, t) defined for 0≤t≤T at

$$t = \frac{n T}{N}$$

for n=0, 1, . . . , N−1.

An AFDM signal may be for example expressed by basis functions of the form

$$w [ m , n ] = \frac{1}{\sqrt{N}} {e}^{- j \frac{2 π}{N} p ( m , n )} .$$

Hence, the bivariate polynomial p(m, n) may be applied at the exponent term of a complex exponential function. It is however noted that any other suitable factor may be used instead or in addition to normalization factor

$$\frac{1}{\sqrt{N}} .$$

In general, a bivariate polynomial may be expressed as f(x, y)=a₁x²+a₂y²+a₃xy+a₄x+a₅y+a₆, where a₁ to a₆ are the coefficients of the different terms of the polynomial. A degree of a term may be defined as the sum of exponents of the term. Hence, the bivariate quadratic polynomial f(x, y)=a₁x²+a₂y²+a₃xy+a₄x+a₅y+a₆ comprises three second degree coefficients a₁ to a₃, two first degree coefficients a₄ and a₅, and one zeroth degree coefficient a₆, i.e., a scalar term. A quadratic term may refer to a term that is raised to the second power. Hence, the above bivariate quadratic polynomial comprises a first quadratic term a₁x² of variable x with coefficient a₁, and a second quadratic term a₂y² of variable y with coefficient a₂. A bivariate polynomial is a bivariate quadratic polynomial if at least one coefficient of at least one of the quadratic terms of the polynomial is non-zero.

According to an embodiment, the bivariate polynomial, p(m, n), characterizing the chirp signals, w[m, n], may comprise

$$p ( m , n ) = {c}_{1} {n}^{2} + {c}_{2} {m}^{2} + \frac{n m}{N} .$$

By proper selection of the first coefficient c₁ and the second coefficient c₂, tolerance of the generated AFDM waveform to impairments in doubly dispersive channels may be improved, as will be further discussed below.

FIG. 2 illustrates an example of a device 200 configured to practice one or more embodiments. Device 200 may be, for example, configured to generate an AFDM signal or receive an AFDM signal. Device 200 may comprise at least one processor 202. The at least one processor 202 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The device 200 may further comprise at least one memory 204. The memory 204 may be configured to store, for example, computer program code or the like, for example operating system software and application software. The memory 204 may comprise one or more volatile memory devices, one or more non-volatile memory devices, and/or a combination thereof. For example, the memory may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.).

Device 200 may further comprise communication interface 208 configured to enable the device 200 to transmit and/or receive information. The communication interface 208 may comprise an internal communication interface such as for example an interface between baseband circuitry and radio frequency (RF) circuitry of a transmitter, receiver, or a transceiver device. Alternatively, or additionally, the communication interface 208 may be configured to provide at least one external wireless radio connection, such as for example a 3GPP mobile broadband connection (e.g. 3G, 4G, 5G); a wireless local area network (WLAN) connection such as for example standardized by IEEE 802.11 series or Wi-Fi alliance; a short range wireless network connection such as for example a Bluetooth connection. The communication interface 208 may hence comprise one or more antennas to enable transmission and/or reception of radio frequency signals over the air.

The device 200 may further comprise other components and/or functions such as for example a user interface (not shown) comprising at least one input device and/or at least one output device. The input device may take various forms such a keyboard, a touch screen, or one or more embedded control buttons. The output device may for example comprise a display, a speaker, a vibration motor, or the like.

When the device 200 is configured to implement some functionality, some component and/or components of the device, such as for example the at least one processor 202 and/or the at least one memory 204, may be configured to implement this functionality. Furthermore, when the at least one processor 202 is configured to implement some functionality, this functionality may be implemented using program code 206 comprised, for example, in the at least one memory 204.

The functionality described herein may be performed, at least in part, by one or more computer program product components such as software components. According to an embodiment, the device 200 comprises a processor or processor circuitry, such as for example a microcontroller, configured by the program code 206, when executed, to execute the embodiments of the operations and functionality described herein. Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), graphics processing units (GPUs), or the like.

The device 200 may be configured to perform method(s) described herein or comprise means for performing method(s) described herein. In one example, the means comprises the at least one processor 202, the at least one memory 204 including program code 206 configured to, when executed by the at least one processor 202, cause the device 200 to perform the method(s).

The device 200 may comprise, for example, a computing device such as for example a modulator chip, a demodulator chip, a baseband chip, a mobile phone, a tablet, a laptop, an internet-of-things device, a base station, or the like. Although the device 200 is illustrated as a single device, it is appreciated that, wherever applicable, functions of the device 200 may be distributed to a plurality of devices, for example between components of a transmitter, a receiver, or a transceiver.

As discussed above, the discrete affine Fourier transform (DAFT) may be applied to generate multi-chirp signals characterized by the coefficients (c₁, c₂) to meet some performance criterion. In the (c₁, c₂)-DAFT domain, a doubly dispersive transmission channel, h[l], with L channel paths, each path characterized with a delay, τₗ, and a Doppler frequency shift vₗ (l∈{1, . . . , L}), is equivalent to a virtual impulse response of the transmission channel with delays 2Nc₁τₗ+vₗ and Doppler shifts τₗ−2Nc₂(2Nc₁τₗ+vₗ) . From diversity perspective, it is thus desirable to choose the coefficients (c₁, c₂) such that the delays 2Nc₁τₗ+vₗ of the virtual impulse response have distinct values for the different paths l. It can be shown that this may be achieved by setting c₁ to be close in absolute value to

$$\frac{1}{2 N} .$$

From a Doppler spread reduction perspective, it is desirable to choose (c₁, c₂) such that the Doppler shifts τₗ−2Nc₂(2Nc₁τₗ+vₗ) of the virtual channel are reduced for each path l. The effective Doppler shift τₗ−2Nc₂(2Nc₁τₗ+vₗ) can be reduced for the different paths l (though possibly in different degrees for different paths) for example by setting

$$( {c}_{1} , {c}_{2} ) = ( {c}_{1 , 0} + {ε}_{1} , {c}_{2} ) = ( \frac{∓ 1}{2 N} + {ε}_{1} , \frac{∓ 1}{2 N} ) ,$$

where ε₁ is a channel parameter, and c_{1,0} is a system parameter

$${c}_{1 , 0} = \frac{∓ 1}{2 N} .$$

The value of the channel parameter, ε₁, may be adapted to the transmission channel 120. For example, the value of the channel parameter, ε₁, may be determined based on channel state information (CSI) of the transmission channel 120. The channel state information may comprise partial CSI such as for example the delay-Doppler profile of the transmission channel 120. High diversity gain may be achieved thanks to the system parameter value

$$\frac{∓ 1}{2 N}$$

in the definition of c₁, which enables each chirp signal to sweep over the entire frequency band of the signal. In general, the system parameter, c_{1,0}, and/or the second coefficient, c₂, may be adjusted to cause a predetermined or desired frequency sweep range for the chirp signals. For example, values of the system parameter, c_{1,0}, and the second coefficient, c₂, may be inversely proportional to the maximum number of chirp signals, N. The system parameter, c_{1,0}, and/or the coefficient, c₂, may be for example selected from a set of system parameter values and/or a set of second coefficient values.

As discussed above, the plurality of chirp signals, w[m, n], may comprise or be based on

$$w [ m , n ] = \frac{1}{\sqrt{N}} {e}^{- j \frac{2 π}{N} p ( m , n )} , where$$

$$p ( m , n ) = {c}_{1} {n}^{2} + {c}_{2} {m}^{2} - \frac{n m}{N} , where {c}_{1} = {c}_{1 , 0} + {ε}_{1} , {c}_{1 , 0} = \frac{∓ 1}{2 N} , {c}_{2} = \frac{∓ 1}{2 N} ,$$

and wherein N is a maximum number of the plurality of chirp signals, w[m, n].

To generate a multi-chirp signal, a device may first obtain a set of input symbols, s[m]. The set of input symbols may comprise application data received for transmission. The obtained set of input symbols may further comprise data generated by the device, such as for example padding data. The set of input symbols may comprise data associated with one or more users, or in general one or more information streams. The device may further modulate a plurality of chirp signals, w[m, n], of the signal based on the set of input symbols. The plurality of chirp signals, w[m, n], may be based on a bivariate polynomial, p(m, n), of input symbol index m and chirp signal time index n. The plurality of chirp signals may be generated using the discrete affine Fourier transform (DAFT) or the inverse discrete affine Fourier transform (IDAFT). The bivariate polynomial, p(m, n), may comprise a first coefficient, c₁, of a quadratic term of the chirp signal time index n and a second coefficient, c₂, of a quadratic term of the input symbol index m. Coefficients c₁ and c₂ may be called DAFT parameters or DAFT coefficients. The first coefficient, c₁, may comprise a sum of a system parameter, c_{1,0}, and a channel parameter, ε₁. This enables to improve tolerance of the generated signal to impairments of a doubly dispersive channel, because the system parameter, c_{1,0}, and the second coefficient, c₂ may be used to increase the frequency sweep range of the chirp signals, which increases frequency diversity. On the other hand the channel parameter, ε₁, enables to mitigate impairments due to Doppler spread.

The value of the channel parameter, ε₁, may be determined based on channel state information. In the N-point (c₁, c₂)-DAFT domain, a time-varying channel with L channel paths, where the lth path (1≤l≤L) has a delay equal to τₗ and a Doppler shift equal to vₗ is equivalent to a virtual channel where the lth path has a delay \tilde{τ}ₗ=2Nc₁τₗ+vₗ and a Doppler shift \tilde{v}ₗ=τₗ−2Nc₂(2Nc₁τₗ+vₗ). Selecting

$${c}_{1} = \frac{1}{2 N} + {ε}_{1} and {c}_{2} = \frac{1}{2 N}$$

leads to \tilde{v}ₗ=vₗ−2Nε₁τₗ. If the values of τₗ and vₗ i.e., the delay-Doppler profile of the channel, are known, then the channel parameter, ε₁, may be determined such that absolute values of the DAFT domain Doppler shifts \tilde{v}ₗ for 1≤l≤L are smaller than the original Doppler shifts, vₗ, with respect to some metric, for example the mean of the absolute values of the DAFT domain Doppler shifts, \tilde{v}ₗ, a weighted mean of these values, or the like. This way, the effect of mobility can be mitigated. The channel state information may comprise an estimated impulse response of the transmission channel 120. The receiver 130 may determine the CSI for example based on reference signals included in the transmitted signal, x[m], and send the CSI to transmitter 110.

The plurality of chirp signals may be orthogonal or substantially orthogonal. The maximum number of chirp signals, N, may refer to a number of chirp signals for which the plurality of chirp signals can be still made orthogonal or substantially orthogonal. It is however noted that all possible chirp signals may not be modulated in some embodiments, for example to provide guard bands, to enable multi-user multiplexing, or the like. The generated signal may be considered as a multicarrier signal comprising a plurality of chirp signals. It is further noted that under practical circumstances hardly any signals are purely orthogonal. Therefore, term ‘substantially orthogonal’ may be understood such that the chirp signals are sufficiently orthogonal for practical applications, for example such that any deviation from strict orthogonality can be compensated by forward error correction methods applied in practical communication systems. Deviations from strict orthogonality may be due to tolerances in practical implementations or approximations of the above formulations.

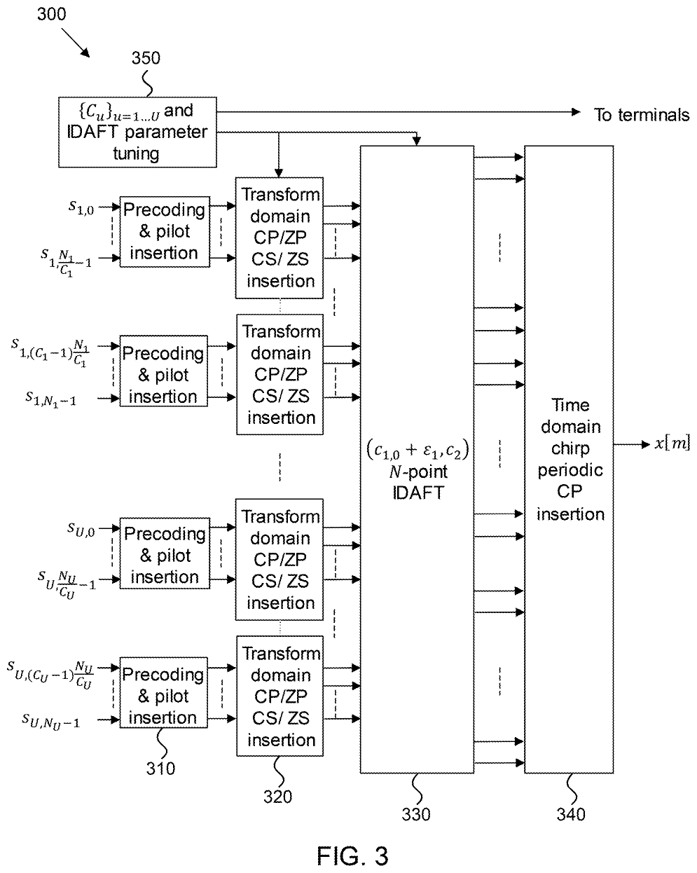

FIG. 3 illustrates an example of a system 300 for generating multi-chirp signals, according to an embodiment. The system 300 may be configured to generate an AFDM signal based on data received from one or a plurality of users. If there are a plurality of users (U>1), the signal may be called an affine frequency division multiple access (AFDMA) signal. The system 300 may be included at transmitter 110, for example as a modulator within baseband circuitry of transmitter 110. A user may be a human user, a particular device, a particular application, or the like.

The system 300 may receive U sets of Nᵤ input symbols, s_{u,n}, for a set of U users. The user index, u, may range from 1 to the number of users, that is, u∈{1, . . . , U}, where the number of users U≥1. The Nᵤ input symbols, s_{u,0}, . . . , s_{u,N}_{ᵤ}₋₁, of user u may be arranged into Cᵤ symbol blocks, where Cᵤ (Cᵤ≥1) indicates the number of symbol blocks for user u. In general, the number of users, U, and/or the number of symbol blocks per user, Cᵤ, may be a positive integers, for example 1, 2, 4, 8, 16, or the like. Each of the U sets of Nᵤ input symbols may be therefore divided into Cᵤ symbol blocks. Each symbol block may be of size

$$⌈ \frac{{N}_{u}}{{C}_{u}} ⌉ ,$$

where ┌┐ denotes the ceil function. The input symbols may comprise data symbols, for example user data symbols or application data symbols, but the input symbols may also include pilot symbols or pilot symbols may be added within the data symbols, as will be further described below. The input symbols may further comprise guard symbols or zero symbols, for example to provide separation between the pilot symbols and the data symbols. Alternatively such guard or zero symbols may be added after pilot insertion.

The system 300 may further comprise at least one precoding and pilot insertion module 310. A precoder may be applied to each of the Cᵤ symbol blocks of each user u. The precoder(s) may therefore comprise

$$⌈ \frac{{N}_{u}}{{C}_{u}} ⌉$$

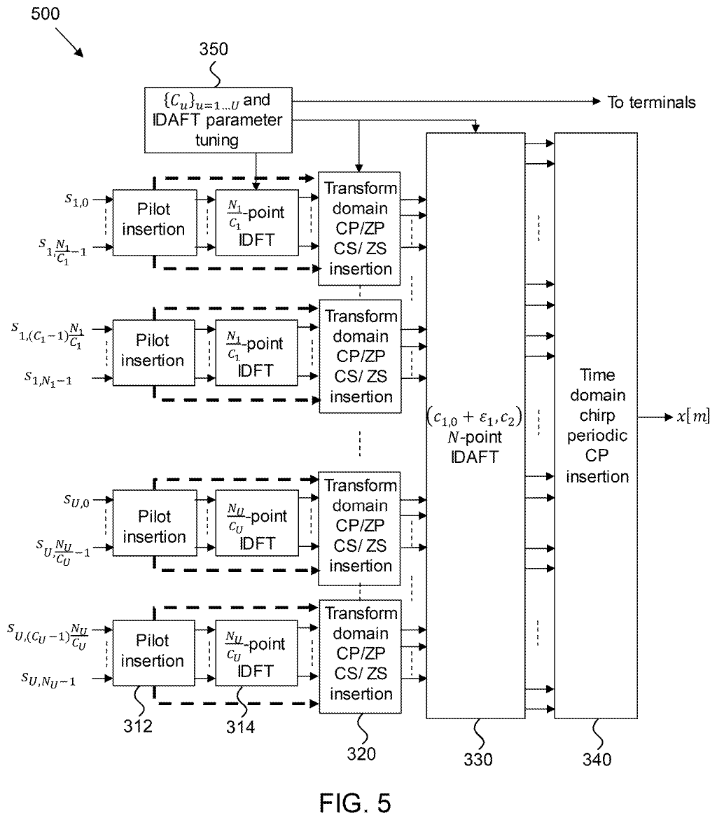

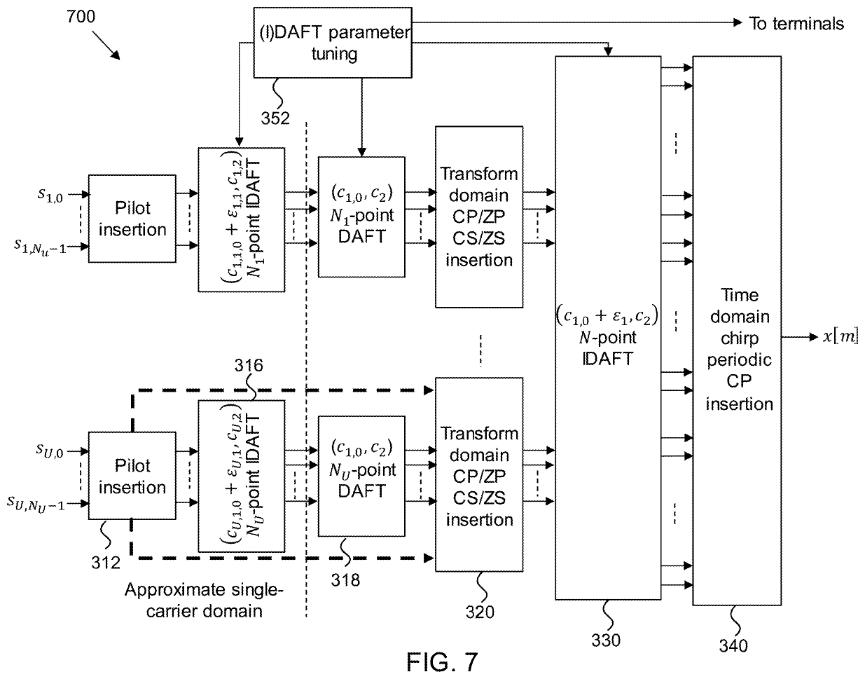

-point precoder(s). A precoder may transform a symbol block into a transform domain. Examples of precoders are described in connection with FIG. 5 and FIG. 7.

As discussed above, pilot symbols may be inserted to the generated signal in order to enable channel estimation or synchronization at receiver 130. Pilot symbols may comprise reference symbols that are known to the receiver 130. Pilot symbols may be inserted at known locations within a resource grid, for example according to a pilot pattern. The resource grid may comprise a plurality of resource elements. A resource element may comprise a particular non-precoded sample, or a transform domain symbol that modulates a chirp signal within a particular time interval.

Pilot symbols may be inserted among the input symbols s_{u,n} at the input of the precoder(s). Pilot symbols may be therefore inserted in the DAFT domain within at least one of the (non-precoded) Cᵤ symbol blocks, for example according to at least one pilot pattern. This enables to use channel estimation pilot patterns similar to pilot patterns of OFDM-based wireless systems, for example 4G or 5G cellular systems, for AFDM. For instance, when the precoder comprises an IDFT module and the inverse precoder comprises a DFT module, the end-to-end effective channel of AFDM has some basic features in common with OFDM end-to-end channels. For instance, the channel matrix associated with the effective channel for AFDM is diagonal or close to diagonal. This enables to use pilot patterns similar to OFDM, since the channel matrix of the effective channel for OFDM has similar properties.

Alternatively, or additionally, pilot symbols may be inserted in the N -point (c₁+ε₁, c₂) -DAFT domain, for example at one or both edges of the output(s) of the precoder(s). Pilot symbols may be therefore inserted at at least one edge of at least one of the precoded Cᵤ symbol blocks, for example as group(s) of adjacent pilot symbols. When this approach is used with MIMO schemes, different pilot symbols belonging to different transmit antennas or spatial layers may be grouped at one or both ends of the symbol blocks, for example instead of using pilot patterns similar to OFDM-based wireless systems, where the pilots may be interleaved throughout the data blocks. The grouped pilot pattern therefore enables lower pilot overhead for MIMO schemes compared to the interleaved pilot approach.

It is therefore possible to insert pilot symbols before or after the precoder within the precoding and pilot insertion module 310. Alternatively, or additionally, the input symbols, s_{u,n}, may already include pilot symbols when provided to the precoding and pilot insertion module 310.

Individual pilot symbols or blocks of pilot symbols may be surrounded, if needed, for example depending on the type of precoding employed, by a sufficient number of guard symbols to limit interference of the pilot symbols to the data symbols. Guard symbols may be inserted for example among some or all of the Cᵤ symbol blocks at the input of the corresponding precoder(s). Alternatively, or additionally, guard symbols may be inserted among the pilot symbols included at the edge(s) of the precoded symbol block(s). The guard symbols may be inserted adjacent to individual pilot symbols or adjacent to blocks of pilot symbols. Performing pilot insertion in the DAFT domain has the advantage of requiring relatively low guard symbol overhead.

In the DAFT domain, the values of the delays 2Nc₁τₗ+vₗ of the virtual channel may be positive or negative depending on the path index, l. Therefore, the system 300 may comprise transform domain cyclic or zero prefix (CP/ZP) and cyclic or zero suffix (CS/ZS) insertion module 320 for one or more of the precoded Cᵤ symbol blocks. The output samples from the precoder(s) of the precoding and pilot insertion module 310 may be concatenated with a sufficient number of zero prefix and zero suffix samples, or alternatively cyclic prefix and cyclic suffix samples, to separate input symbols belonging to different symbol blocks. In general, a prefix and a suffix may be inserted for one or more of the precoded Cᵤ symbol blocks. The DAFT domain suffixes and prefixes serve for two purposes: 1) The prefixes and suffixes inserted at outer edges of the first symbol block

$$( {s}_{u , 0} , … , {s}_{u , \frac{{N}_{u}}{{C}_{u}} - 1} )$$

and last symbol block

$$( {s}_{u , ( {C}_{u} - 1 ) \frac{{N}_{u}}{{C}_{u}}} , … , {s}_{u , {N}_{u} - 1} )$$

of each user enable to avoid multi-user interference. 2) These edge prefixes and suffixes in combination with prefixes and suffixes inserted between the Cᵤ symbol blocks (when Cᵤ>1) of each user make the DAFT domain channel matrices experienced by the DAFT domain samples between the prefix and suffix close to circulant. Hence, the precoding and inverse precoding, for example Nᵤ-point IDFT precoding and a Nᵤ-point DFT inverse precoding, for transmission on Nᵤ DAFT sub-carriers results in close-to-zero inter-carrier interference (ICI) and thereby enables using a low-complexity one-tap equalization. Furthermore, the overhead associated with these suffixes and prefixes is at most of the order of the delay spread plus the Doppler spread and therefore interference may be avoided without significant overhead.

The precoded samples of the user(s) may be then concatenated and the resulting aggregated N-long vector of samples may be fed to an N-point inverse DAFT (IDAFT) 330. The N-point IDAFT 330 may be therefore applied to an aggregation of the U sets of Nᵤ (precoded) input symbols. The N-point IDAFT 330 may be characterized by the coefficients (c₁, c₂)=(c_{1,0}+ε₁, c₂) and therefore configured to generate a plurality of chirp signals characterized by the bivariate polynomial, p(m, n). The system parameter, c_{1,0}, and the second coefficient, c₂, may be equal or close to

$$\frac{∓ 1}{2 N}$$

to cause each chirp signal to sweep through the entire signal bandwidth. However, other values of c_{1,0} and c₂ may be selected to adjust the frequency sweep range. The channel parameter, ε₁, may be determined based on channel state information received from, or determined for, the U multiplexed users, for example the delay-Doppler-power profiles of their respective channels. The CSI may be reported by the U receivers to the system 300 for example using feedback messages or the CSI may be estimated by the system 300 based on pilot symbols transmitted by the U receivers, for example based on assuming reciprocity of the transmission channel 120. The output of the N-point IDAFT 330, which comprises multiple chirp signals modulated by input symbols, may be called a multi-chirp symbol or an AFDM(A) symbol.

The system 300 may further comprise time domain chirp periodic cyclic prefix insertion 340, which may append the time-domain samples at the output of the N-point IDAFT 330 with a chirp-periodic prefix and provide the generated signal, x[m], to further stage(s) of transmitter 110 and eventually to receiving terminals over a radio interface. The samples of the chirp periodic cyclic prefix may be determined as a function of both the time-domain samples of this multi-chirp symbol and the IDAFT parameters c_{1,0}, ε₁, and/or c₂. This prefix enables to avoid interference between consecutive multi-chirp symbols.

The system 300 may further comprise an IDAFT controller 350, which may be configured to tune values of the IDAFT parameters c_{1,0}, ε₁, and/or c₂. The IDAFT controller 350 may also determine the number of symbol blocks, Cᵤ, for each user. The number of symbol blocks may be user-specific or common to a plurality of users. Furthermore, the IDAFT controller 350 may control prefix and suffix insertion in the DAFT domain. The IDAFT controller 350 may for example determine the length of the prefix and/or the length of the suffix as a function of the IDAFT parameters and the channel state information of user u, for example the first coefficient, c₁, and the second coefficient, c₂, and the delay-Doppler profile of the transmission channel of user u. For example, assuming a time-varying channel with L channel paths, where the lth path (1≤l≤L) has a delay equal to τₗ and a normalized Doppler shift equal to vₗ, the length of the cyclic prefix or the length of the zero suffix may be determined based on

$${Q}_{p} + {max}_{l = 1 … L} ⌊ {( 2 {c}_{1} N {τ}_{1} + {v}_{l} )}_{+} ⌋ .$$

Here, Qₚ stands for a minimal cyclic prefix (or zero suffix) length, which is a system parameter that can be set to zero, while (x)₊ denotes max(x, 0) for some real value x, and |x| stands for the floor of x. Length of the cyclic suffix or the length of the zero prefix may be determined based on

$${Q}_{s} + {max}_{l = 1 … L} ⌊ \vert {( 2 {c}_{1} N {τ}_{1} + {v}_{l} )}_{-} \vert ⌋ .$$

Here, Qₛ stands for a minimal cyclic suffix (or zero prefix) length, which is a system parameter that may be set to zero, while (x)₋ denotes min(x, 0) for some real value x, and |x| stands for the absolute value of x. This enables to optimize the length of the prefix and the suffix such that sufficient protection against interference is provided without causing unnecessary overhead.

According to an embodiment, an indication of at least one of the IDAFT parameters, for example the first coefficient, c₁, the system parameter, c_{1,0}, the channel parameter, ε₁, and/or the second coefficient, c₂, may be transmitted to all or some of the U users, for example to receiver 130 or other terminal. The indication may comprise value(s) of the IDAFT parameter(s). The indication may be provided for example in one or more signaling or control messages. The transmitter system 300 may provide the indication of the determined IDAFT parameters to the receiver 130 for example over a control channel using a waveform which is known to the receiver 130, for example a chirp waveform characterized by predetermined IDAFT parameters, or some other known waveform. The indication may comprise a bit, a sequence of bits, or other combination of bits, where particular values of the bit(s) indicate particular value(s) of the IDAFT parameter(s). Some of the IDAFT parameters may be configurable by this signaling and some of the parameters may be fixed. Mapping between bit values and the configurable IDAFT parameter values may be predetermined or signaled by the transmitter system 300 to the receiver 130, for example over higher layer signaling such as for example Layer 2 (link layer) signaling. Communication layers may be defined for example based on the OSI (Open Systems Interconnection) model or a layer structure of a particular standard. An indication of the lengths of the cyclic/zero prefix and suffix and/or the number of symbol blocks, Cᵤ, may be provided in a similar fashion.

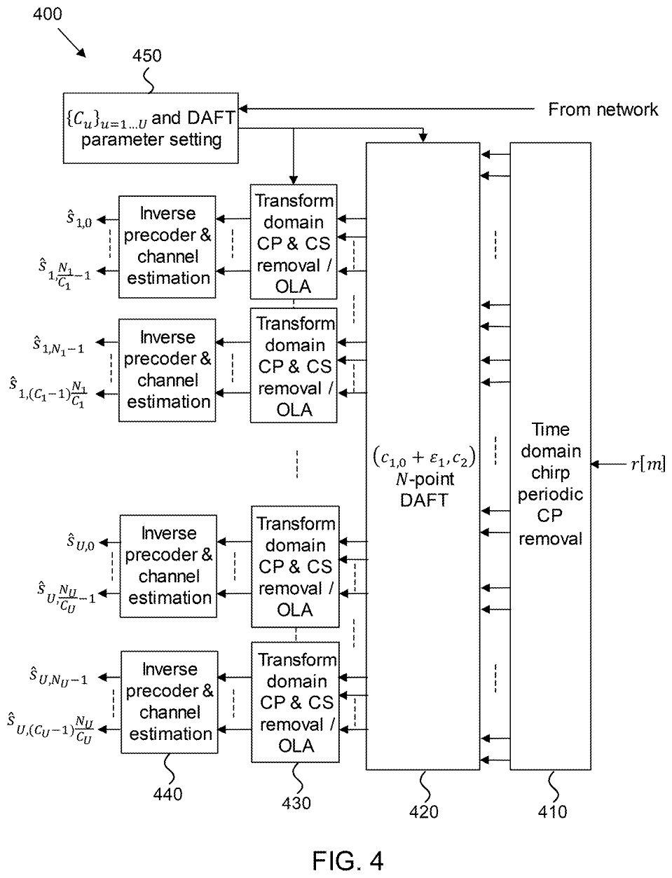

FIG. 4 illustrates an example of a system 400 for receiving multi-chirp signals, according to an embodiment. The system 400 may demodulate the received signal based on performing inverse operations compared to the system 300. The system 400 may be included at receiver 130, for example as a demodulator within baseband circuitry of receiver 130. It is however noted that not all of the illustrated functions or modules may be included in practical implementations. For example, system 400 may be configured to demodulate data for one user or a subset of users instead of all U users.

The system 400 may comprise a time domain chirp periodic cyclic prefix removal module 410 to remove the cyclic prefix added at 340 from the received signal, r[m]. The system 400 may further comprise an N-point DAFT 420 for transforming the received signal into the DAFT domain. The N-point DAFT 420 may be characterized by the first coefficient, c₁, and the second coefficient, c₂. The first coefficient may comprise a sum of the system parameter, c_{1,0}, and the channel parameter, ε₁. The system 400 may receive an indication of at least one of the DAFT parameters, for example the first coefficient, c₁, the system parameter, c_{1,0}, the channel parameter, ε₁, and/or the second coefficient, c₂, and apply the DAFT 420 based on the received indication.

The system 400 may further comprise transform domain cyclic prefix and suffix removal 430 to eliminate the cyclic prefix and the cyclic suffix. The cyclic prefix and suffix may be eliminated by removing symbols of the cyclic prefix and the cyclic suffix. Alternatively, in embodiments where zero suffixes and zero prefixes are inserted at the transmitter 110 instead of cyclic prefixes and cyclic suffixes, the zero-valued prefix and the zero-valued suffix may be eliminated based on an overlap-add (OLA) algorithm. The OLA algorithm may comprise adding samples received at positions of the zero prefix(es) and suffix(es) to samples received at positions of a number of data samples equal to the number of prefix or suffix samples that are located at the opposite edge of the prefix or suffix sample block. The cyclic prefix/suffix removal or OLA may be applied based on a received indication of the length of the prefix and suffix. Lengths of the prefix and suffix may be user-specific.

The system 400 may further comprise an inverse precoder and channel estimation module 440 for one or more users and one or more symbol blocks of the user(s). Hence, the receiver system 400 may comprise up to Cᵤ per-user

$$⌈ \frac{{N}_{u}}{{C}_{u}} ⌉$$

-point inverse precoding and channel estimation modules. Depending on the stage where the pilot symbols have been inserted at the transmitter 110, the channel estimation may be performed before or after the inverse precoding.

If pilot symbols have been inserted after precoding, the system 400 may perform channel estimation before inverse precoding. The system 400 may for example determine a channel estimate based on the pilot symbols included at least one edge of the at least one of the Cᵤ symbol blocks of the received signal, r[m]. The system 400 may then equalize the received data symbols based on the channel estimate and provide the equalized DAFT-domain data symbols to the inverse precoder(s), which may output estimates of the input symbols, ŝ_{u,n}, for one or more users.

If pilot symbols have been inserted before precoding, the system 400 may perform channel estimation after inverse precoding. The symbols output by the N-point DAFT 420 may be first processed by the inverse precoder(s). The system 400 may then determine a channel estimate based on pilot symbols included within the inversely precoded Cᵤ symbol block(s). The system 400 may equalize the inversely precoded data symbols based on the channel estimate and output estimates of the input symbols, ŝ_{u,n}, for one or more users.

The system 400 may further eliminate guard symbols located adjacent to individual pilot symbols or adjacent to blocks of pilot symbols, either before or after the inverse precoding. The guard symbols may be for example removed before providing the demodulated data to further receiver stages.

The system 400 may further comprise a DAFT controller 450 for receiving the indication of one or more of the DAFT parameter(s) (cf. IDAFT parameters in the transmitter) and for setting the DAFT parameters accordingly. Some or all of the DAFT parameters may be fixed, for example defined in a standard, but some or all of the DAFT parameters may be configured based on the received indication. If the receiver system 400 is implemented at a terminal, such as for example user equipment, the indication may be received from the network, for example from a base station. The DAFT controller 450 may also determine the number of symbol blocks, Cᵤ, for each user, for example based on pre-configured information or an indication of the number of symbol blocks received for example from transmitter 110.

FIG. 5 illustrates an example of a system 500 with an inverse discrete Fourier transform (IDFT) based precoder for generating multi-chirp signals, according to an embodiment. The system 500 may comprise functions and modules similar to system 300 and be implemented within transmitter 110 in a similar fashion. However, an

$$\frac{{N}_{u}}{{C}_{u}}$$

-point IDFT 314 may be used as a precoder. As illustrated in the figure, an

$$\frac{{N}_{u}}{{C}_{u}}$$

-point IDFT may be applied to each of the Cᵤ symbol blocks of the one or more users. The system 500 may further comprise pilot insertion 312 before the

$$\frac{{N}_{u}}{{C}_{u}}$$

-point IDFT 314. It is however noted that pilot insertion may be performed either before the

$$\\ \frac{{N}_{u}}{{C}_{u}}$$

-point IDFT 314, for example by making some of the input symbols, s_{u,0}, . . . , s_{u,N}_{ᵤ}₋₁, to be known pilot symbols according to a pilot pattern, or, after the

$$\\ \frac{{N}_{u}}{{C}_{u}}$$

-point IDFT 314, for example by inserting pilot symbols at one or both edges of the sample blocks produced by some or all of the

$$\\ \frac{{N}_{u}}{{C}_{u}}$$

-point IDFT 314, optionally with one or more guard samples separating the pilot symbols from the symbol blocks. It is further noted that IDFT may be implemented or approximated by any suitable algorithm such as for example the inverse fast Fourier transform (IFFT). In this embodiment, the IDAFT controller 350 may also control the size(s) of the IDFT(s) based on the size(s) of the symbol blocks, for example such that IDFT size is equal to symbol block size, or such that any symbol block fits within the corresponding IDFT. An indication of the size(s) of the symbol block(s) may be transmitted to the receiver 130.

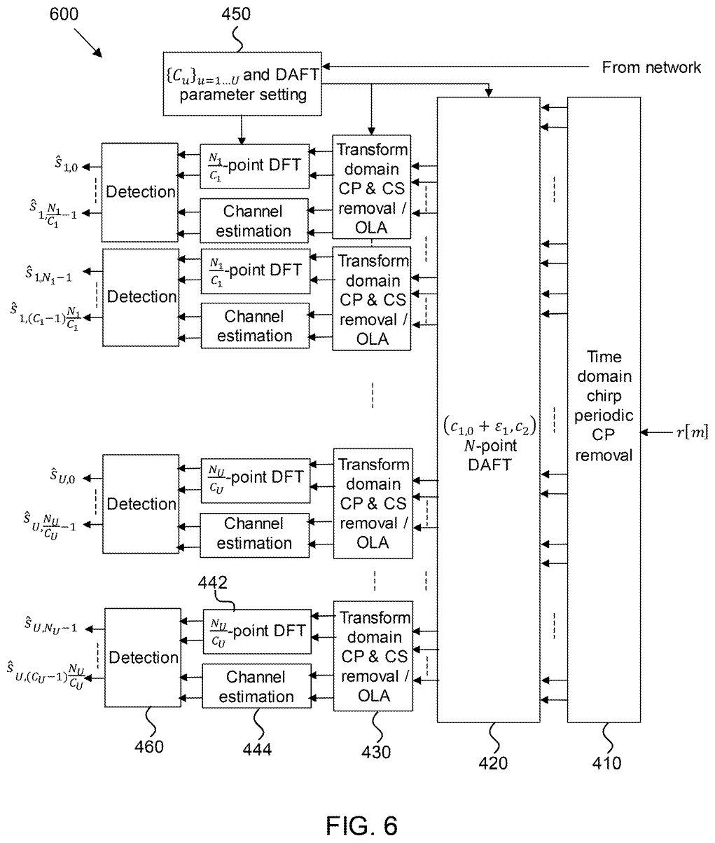

FIG. 6 illustrates an example of a system 600 with a discrete Fourier transform (DFT) based inverse precoder for receiving multi-chirp signals, according to an embodiment. The system 600 may comprise functions and modules similar to system 400 and be implemented within receiver 130 in a similar fashion. However, an

$$\\ \frac{{N}_{u}}{{C}_{u}}$$

-point DFT 442 may be used as an inverse precoder. An

$$\\ \frac{{N}_{u}}{{C}_{u}}$$

-point DFT may be applied to each of the Cᵤ symbol blocks of at least one of the users u. The DFT may be implemented or approximated by any suitable algorithm such as for example the fast Fourier transform (FFT). The system 600 may further comprise channel estimation 444, which may estimate the channel in parallel with the

$$\\ \frac{{N}_{u}}{{C}_{u}}$$

-point DFT 442 based on pilot symbols inserted after the

$$\\ \frac{{N}_{u}}{{C}_{u}}$$

-point IDFT precoder at the transmitter 110. As discussed above, it is also possible that the transmitter 110 inserts pilots before the

$$\\ \frac{{N}_{u}}{{C}_{u}}$$

-point IDFT precoder. In this case, channel estimation 44 may be performed sequentially with the

$$\\ \frac{{N}_{u}}{{C}_{u}}$$

-point DFT 442, that is, based on pilot symbols included within the output of the

$$\\ \frac{{N}_{u}}{{C}_{u}}$$

-point DFT 442.

The DAFT controller 450 may control the size(s) of the DFT(s) based on the size(s) of the symbol blocks, for example such that IDFT size is equal to symbol block size, or such that any symbol block fits within the corresponding IDFT. An indication of the size(s) of the symbol block(s) may be received from transmitter 110.

The system 600 may further comprise a detection module 460, which may be configured to determine estimates of the input symbols, ŝ[m], based on the channel estimate and the symbols inversely precoded by the

$$\\ \frac{{N}_{u}}{{C}_{u}}$$

-point DFT 442. The IDFT and DFT-based embodiments of FIG. 5 and FIG. 6 enable implementation of the disclosed ADFM signals with low complexity and to use pilot patterns similar to OFDM-based wireless communication systems, as described above.

FIG. 7 illustrates an example of a system 700 with an inverse discrete affine Fourier transform (IDAFT) and discrete affine Fourier transform (DAFT) based precoder for generating multi-chirp signals, according to an embodiment. The system 700 provides a single-carrier affine frequency division multiple access (SC-AFDMA) transmission scheme, which may be used to multiplex different users with different propagation conditions and/or different service requirements. These properties translate into different requirements in terms of IDAFT parameter values for different users, which is taken into account in the disclosed SC-AFDMA scheme. In the example of FIG. 7, the number of symbols blocks Cᵤ=1 for each user. It is however noted that the system 700 may be generalized to more than one symbol block per user and therefore the system 700 may comprise a plurality of IDAFT/DAFT based precoders for one or more of the users.

The system 700 may comprise functions and modules similar to system 300 and 500 and be implemented within transmitter 110 in a similar fashion. However, system 700 may use as a precoder a combination of Nᵤ-point IDAFT 316 and Nᵤ-point DAFT 318. Nᵤ may refer to the number of input symbols for user u. As illustrated in FIG. 7, such precoder may be provided for each user. The Nᵤ-point IDAFT 316 may be characterized by user-specific IDAFT parameters (c_{u,1}, c_{u,2})=(c_{u,1,0}+ε_{u,1}, c_{u,2}), where c_{u,1,0} is a user-specific system parameter, ε_{u,1} is a user-specific channel parameter, and c_{u,2} is a second user-specific coefficient. The first user-specific coefficient, c_{u,1}, may comprise a sum of the user-specific system parameter, c_{u,1,0}, and the user-specific channel parameter ε_{u,1}, that is, c_{u,1}=c_{u,1,0}+ε_{u,1}. The user-specific coefficients may be applied in the Nᵤ-point IDAFT 316 as coefficients of a user-specific polynomial

$$\\ {p}_{u} ( m , n ) = {c}_{u , 1} {n}^{2} + {c}_{u , 2} {m}^{2} + \frac{nm}{{N}_{u}} ,$$

similar to the N-point IDAFT 330. The user-specific system parameter, c_{u,1,0}, enables to control the frequency sweep range of chirp signals separately for each user. The user-specific channel parameter, ε_{u,1}, may be determined based on channel state information of a particular user. This enables to mitigate impairments due to Doppler spread separately depending for example on the current mobility scenario of each user.

The Nᵤ-point DAFT 318 may be characterized by parameters (c_{1,0}, c₂), that is, the system parameter and the second coefficient, as described in connection with FIG. 3. These parameters may be applied as a common system parameter and a common second coefficient, which are common for a plurality of users. For the Nᵤ-point DAFT 318, the first coefficient c₁ may be equal to the (common) system parameter c_{1,0}. Hence, the Nᵤ-point DAFT 318 may be applied independent of channel state information. The Nᵤ-point DAFT 318 may take as input the symbols provided by the Nᵤ-point IDAFT 316.

According to an embodiment, the channel parameter, ε₁, of the N-point IDAFT 330 may be equal to zero. This enables to control the characteristics of the generated signal by the user-specific IDAFT parameters to and thereby to mitigate channel impairments individually for each user. It is however also possible to use a non-zero channel parameter ε₁ in the N-point IDAFT 330. The (common) channel parameter ε₁ may be for example determined based on channel state information that comprises an aggregation of channel state information of the set of U users u∈{1, . . . , U}. This enables to mitigate the channel impairments both individually and simultaneously for multiple users. For example, setting the (common) channel parameter, ε₁, to a value tuned to the aggregate channel state information enables a reduced effective Doppler spread for the signal samples at the output of the N-point DAFT 420 at the receiver for all the multiplexed users. The exact amount of this reduction may however vary from one user to another. Since the users' signals are de-multiplexed and the guard samples separating the users are discarded at this level, the simultaneous reduction in Doppler spread for multiple users translates into the possibility of using fewer guard samples to separate their respective signals, which increases the data throughput of the system.

Furthermore, tuning the user-specific channel parameter, ε_{u,1}, based on the individual channel state information of user u allows to reduce the effective Doppler spread experienced by the signal samples of the user at the output of the Nᵤ-point DAFT module 448. The reduction of effective Doppler spread can for example be translated into a reduction in the pilot overhead needed for estimating the effective channel of user u, or to reduce the computational complexity needed for channel equalization and data detection.

The aggregation of channel state information may for example comprise an aggregate delay-Doppler profile. The individual delay-Doppler profile of user u comprises the set of delay Doppler pairs, {(τ_{u,1}, v_{u,1}), . . . , (τ_{u,L}_{ᵤ}, v_{u,L}_{ᵤ})}, where Lᵤ is the number of propagation paths of user u, where τ_{u,l} is the delay of the l-th path, and where v_{u,l} is the Doppler frequency shift of the l-th path. The aggregate delay-Doppler profile of the users may comprise a union of the set of delay-Doppler pairs, {(τ_{u,1}, v_{u,1}), . . . , (τ_{u,L}_{ᵤ}, v_{u,L}_{ᵤ})}, for the plurality of users u∈{1, . . . , U}. In other words, the aggregate delay-Doppler profile may comprise the delay-Doppler profile of a virtual channel comprised of all the propagation paths of all the users u∈{1, . . . , U}.

The (I)DAFT controller 352, which may have functionality similar to IDAFT controller 350, may be configured to tune the user-specific IDAFT parameters, e.g. c_{u,1,0}, c_{u,2}, and/or ε_{u,1} in addition, or as an alternative, to tuning the common (I)DAFT parameters, e.g. c_{1,0}, c₂, and/or ε₁. The (I)DAFT controller 352 may further provide an indication of at least one of the user-specific IDAFT parameters, e.g. first user-specific coefficient, c_{u,1}, the second user-specific coefficient, c_{u,2}, the user-specific system parameter, c_{u,1,0}, and/or the user-specific channel parameter, ε_{u,1}. The indication may be transmitted to receiver 130 similar to the indication of the common (I)DAFT parameter(s), e.g. the first coefficient, c₁, the system parameter, c_{1,0}, the channel parameter, ε₁, and/or the second coefficient, c₂. However, the indication of the user-specific IDAFT parameter(s) may not be transmitted to all receivers. For example, the indication of user-specific IDAFT parameter(s) may be included in a control message or signaling message that is addressed to a particular receiver or a subset of receivers.

Pilot insertion 312 may add pilot symbols before the Nᵤ-point IDAFT 316 or after the Nᵤ-point DAFT 318. The pilot insertion 312 and the Nᵤ-point IDAFT 316 are located in an approximate single-carrier domain, where the signal has properties similar to a single-carrier signal. Hence, for example a low peak-to-average power ratio (PAPR) may be achieved. In addition to the (I)DAFT parameters, the (I)DAFT controller 352 may control the size Nᵤ of the IDAFT 316 and DAFT 318, which may be user-specific. An indication of the (I)DAFT size, Nᵤ, may be transmitted to receiver 130.

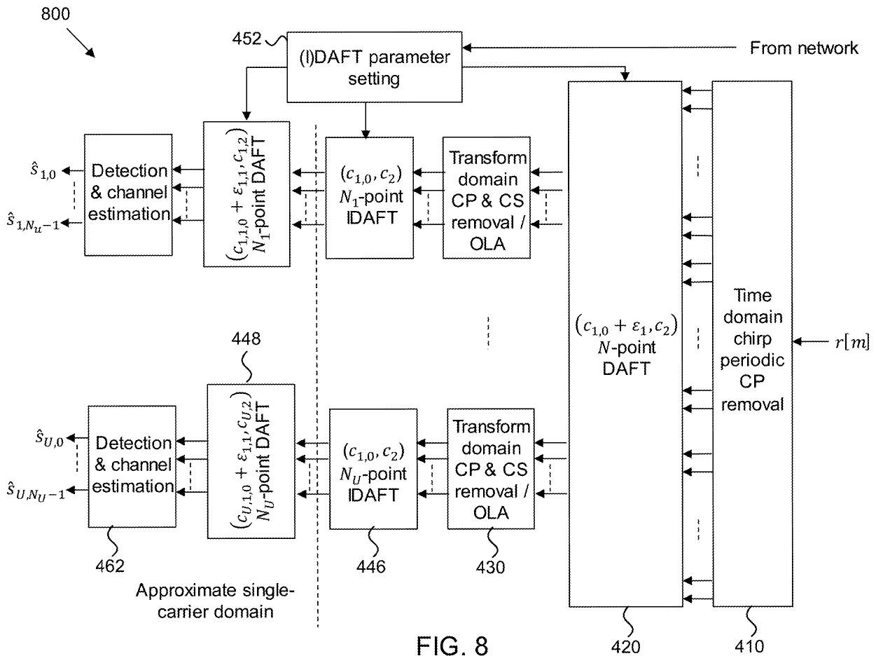

FIG. 8 illustrates an example of a system 800 with an IDAFT and DAFT based inverse precoder for receiving multi-chirp signals, according to an embodiment. The system 800 enables reception of SC-AFDMA signals. In the example of FIG. 8 the number of symbols blocks Cᵤ=1 for each user u, but the system may be generalized to more than one symbol block per user, as discussed above. Therefore, the system 800 may include a plurality of IDAFT/DAFT based inverse precoders for one or more of the users.

The system 800 may comprise functions and modules similar to systems 400 or 600 and be implemented within receiver 130 in a similar fashion. For example, detection and channel estimation module 462 may comprise functions similar to channel estimation 444 and detection module 460. However, system 800 may use as an inverse precoder a combination of Nᵤ-point IDAFT 446 and Nᵤ-point DAFT 448. Such inverse precoder may be provided for one or more of the U users served by the received signal, r[m].

The Nᵤ-point IDAFT 446 may be characterized by parameters (c_{1,0}, c₂), that is, the system parameter and the second coefficient, as described in connection with FIG. 3 and FIG. 7. These parameters may be common for a plurality of users. For the Nᵤ-point IDAFT 446, the first coefficient c₁ may be equal to the (common) system parameter c_{1,0} and therefore the Nᵤ-point IDAFT 446 may be applied independent of channel state information.

The Nᵤ-point DAFT 448 may be characterized by user-specific DAFT parameters (c_{u,1}, c_{u,2})=(c_{u,1,0}+ε_{u,1}, c_{u,2}), where c_{u,1,0} comprises a user-specific system parameter, ε_{u,1} comprises a user-specific channel parameter, and c_{u,2} comprises a second user-specific coefficient. The first user-specific coefficient c_{u,1} may comprise a sum of the user-specific system parameter c_{u,1,0} and the user-specific channel parameter where ε_{u,1}, that is, c_{u,1}=c_{u,1,0}+ε_{u,1}. The Nᵤ-point DAFT 448 may take as input the symbols provided by the Nᵤ-point IDAFT 446.

The (I)DAFT controller 452, which may have functionality similar to DAFT controller 450, may receive an indication of at least one user-specific DAFT parameter, for example the first user-specific coefficient, c_{u,1}, the second user-specific coefficient, c_{u,2}, the user-specific system parameter, c_{u,1,0}, and/or the user-specific channel parameter, ε_{u,1}. The indication of the user-specific DAFT parameter(s) may be received for example in a control message or signaling message that is addressed to a particular receiver or a subset of receivers. Some or all of the user-specific DAFT parameters may be configured by the (I)DAFT controller 452 based on the received indication, which enables dynamic adaptation of the user-specific DAFT parameters. However, some or all of the user-specific DAFT parameters may be predetermined, for example specified in a standard. Transmitting the indication of the user-specific DAFT parameters may be therefore optional. The same applies to the common (I)DAFT parameters of the N-point DAFT 420 and the Nᵤ-point IDAFT 446. In addition to the (I)DAFT parameters, the (I)DAFT controller 452 may determine the size Nᵤ of the DAFT 446 and IDAFT 448, which may be user-specific. An indication of the DAFT/IDAFT size, Nᵤ, may be received from transmitter 110.

The disclosed AFDM signals provide several benefits. For example, since a doubly dispersive channel with delays τₗ and Doppler shifts vₗ is in the (c₁, c₂)-DAFT domain equivalent to the impulse response of a virtual doubly dispersive channel with delays 2Nc₁τₗ+vₗ and Doppler shifts τₗ−2Nc₂(2Nc₁τₗ+vₗ) , it can be shown that with the disclosed DAFT parameter setting a full diversity on doubly dispersive channels may be achieved, as opposed to OFDM, single-carrier modulation, and even orthogonal time frequency space (OTFS) based methods when no OTFS diversity enhancement schemes are employed. With the disclosed DAFT parameter setting, channel paths satisfying the following can be identified for each AFDM sub-carrier: 1) channel paths with close delay values but different Doppler shifts, or 2) channel paths with close Doppler shift values but different delays. This high-diversity property of the disclosed AFDM signals translates into gain in reliability, better quality of service, and lower latency for urgent data transmission.

Furthermore, the disclosed AFDM signals improve robustness on high-mobility and/or high-frequency channels. With N-point AFDM, a transmission from/to a device u on Nᵤ≤N DAFT sub-carriers and employing an Nᵤ-point IDFT precoding at the transmitter side, and respectively an Nᵤ-point DFT processing at the receiver side, provides robustness against mobility, carrier frequency offset (CFO), and phase noise (PN) comparable to a (virtual) Nᵤ-point OFDM transmission, irrespective of the value of N. Since in most multi-user applications Nᵤ<<N for any user u, AFDM is much more robust than OFDMA against mobility and high-frequency impairments. Thanks to this robustness, N-point AFDM with large values of N can be used on high-frequency channels without affecting the quality of service for the multiplexed users. Since larger value of N means that the overhead related to guard, prefix, and suffix samples becomes relatively negligible, this translates into a high data throughput gain. It is further noted that the advantages may be achieved without the need for complex receiver schemes.

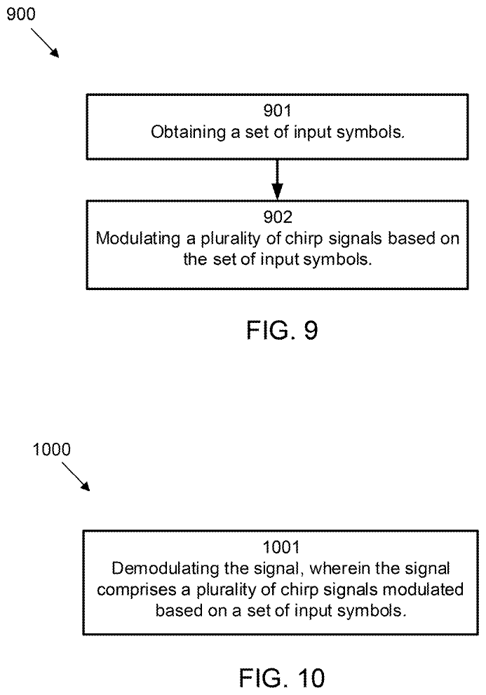

FIG. 9 illustrates an example of a method 900 for generating a signal, according to an embodiment,

At 901, the method may comprise obtaining a set of input symbols.

At 902, the method may comprise modulating a plurality of chirp signals (w[m, n]) based on the set of input symbols. The plurality of chirp signals (w[m, n]) may be based on a bivariate polynomial (p(m, n)) of input symbol index m and chirp signal time index n. The bivariate polynomial (p(m, n)) may comprise a first coefficient (c₁) of a quadratic term of the chirp signal time index n and a second coefficient (c₂) of a quadratic term of the input symbol index m. The first coefficient (c₁) may comprise a sum of a system parameter (c_{1,0}) and a channel parameter (ε₁).

FIG. 10 illustrates an example of a method 1000 for receiving a signal, according to an embodiment of the disclosure.

At 1001, the method may comprise demodulating the signal, wherein the signal comprises a plurality of chirp signals (w[m, n]) modulated based on a set of input symbols. The plurality of chirp signals (w[m, n]) may be based on a bivariate polynomial (p(m, n)) of input symbol index m and chirp signal time index n. The bivariate polynomial (p(m, n)) may comprise a first coefficient (c₁) of a quadratic term of the chirp signal time index n and a second coefficient (c₂) of a quadratic term of the input symbol index m. The first coefficient (c₁) may comprise a sum of a system parameter (c_{1,0}) and a channel parameter (ε₁).

Further features of the methods directly result from the functionalities and parameters of the methods and devices, for example the transmitter 110, the receiver 130, device 200, or systems 300, 400, 500, 600, 700, or 800, as described in the appended claims and throughout the specification and are therefore not repeated here.

A device or a system may be configured to perform or cause performance of any aspect of the method(s) described herein. Further, a computer program may comprise program code configured to cause performance of an aspect of the method(s) described herein, when the computer program is executed on a computer. Further, the computer program product may comprise a computer readable storage medium storing program code thereon, the program code comprising instruction for performing any aspect of the method(s) described herein. Further, a device may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

The functions and modules of systems 300, 400, 500, 600, 700, 800 may be implemented by any suitable means, for example at device 200. Hence, the systems 300, 400, 500, 600, 700, 800 may comprise necessary software and/or hardware, such as for example processing circuitry and memory, for implementing said functions or modules.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items. Furthermore, references to ‘at least one’ item or ‘one or more’ items may refer to one or a plurality of those items.

The operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or device may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

What is claimed is:

1. A device (110, 200, 300, 500, 700) for generating a signal, the device configured to:
obtain a set of input symbols; and
modulate a plurality of chirp signals, w[m, n], based on the set of input symbols, wherein the plurality of chirp signals, w[m, n], are based on a bivariate polynomial, p(m, n), of input symbol index m and chirp signal time index n, wherein the bivariate polynomial, p(m, n), comprises a first coefficient, c₁, of a quadratic term of the chirp signal time index n and a second coefficient, c₂, of a quadratic term of the input symbol index m, and wherein the first coefficient, c₁, comprises a sum of a system parameter, c_{1,0}, and a channel parameter, ε₁.

2. The device (110, 200, 300, 500, 700) according to claim 1, wherein the system parameter, c_{1,0}, and the second coefficient, c₂, are configured to cause a predetermined frequency sweep range for the plurality of chirp signals, w[m, n], and wherein the device is further configured to determine the channel parameter, ε₁, based on channel state information of a transmission channel.

3. The device (110, 200, 300, 500, 700) according to claim 2, wherein the channel state information comprises a delay-Doppler profile of the transmission channel.

4. The device (110, 200, 300, 500, 700) according to claim 2, wherein the channel state information comprises an estimated impulse response of the transmission channel, and wherein the device is further configured to:
transform the estimated impulse response of the transmission channel to an affine Fourier transform domain characterized by the first coefficient, c₁, and the second coefficient, c₂, to obtain a virtual impulse response of the transmission channel; and
determine the channel parameter, ε₁, such that a mean or a weighted mean of Doppler shifts of paths of the virtual impulse response of the transmission channel is smaller than a mean or a weighted mean of Doppler shifts of paths of the estimated impulse response of the transmission channel.

5. The device (110, 200, 300, 500, 700) according to claim 1, wherein the system parameter, c_{1,0}, and the second coefficient, c₂, are inversely proportional to N, wherein N is a maximum number of the plurality of chirp signals, w[m, n].

6. The device (110, 200, 300, 500, 700) according to claim 1, wherein the plurality of chirp signals, w[m, n], are based on:
$$w [ m , n ] = \frac{1}{\sqrt{N}} {e}^{- j \frac{2 π}{N} p ( m , n )} ,$$
$$\\ where p ( m , n ) = {c}_{1} {n}^{2} + {c}_{2} {m}^{2} - \frac{nm}{N} ,$$
$$\\ where {c}_{1} = {c}_{1 , 0} + {ε}_{1} , {c}_{1 , 0} = \frac{\pm 1}{2 N} , {c}_{2} = \frac{\pm 1}{2 N} ,$$
and
wherein N is a maximum number of the plurality of chirp signals, w[m, n].

7. The device (110, 200, 300, 500, 700) according to claim 1, further configured to:
receive U sets of Nᵤ input symbols for a set of U users, where u∈{1, . . . , U}, and wherein U≥1;
divide each of the U sets of Nᵤ input symbols into Cᵤ symbol blocks, wherein Cᵤ≥1;
apply a precoder for each of the Cᵤ symbol blocks;
insert a prefix and a suffix for each of the precoded Cᵤ symbol blocks; and
apply an N-point inverse discrete affine Fourier transform (330) characterized by the first coefficient, c₁, and the second coefficient, c₂, to an aggregation of the U sets of Nᵤ input symbols, wherein N is a maximum number of the plurality of chirp signals, w[m, n].

8. The device (110, 200, 500) according to claim 7, wherein the precoder comprises an
$$\\ ⌈ \frac{{N}_{u}}{{C}_{u}} ⌉$$
-point inverse discrete Fourier transform (314).

9. The device (110, 200, 700) according to claim 7, wherein Cᵤ=1 and wherein the precoder comprises:
an Nᵤ-point inverse discrete affine Fourier transform (316) characterized by a first user-specific coefficient, c_{u,1}, and a second user-specific coefficient, c_{u,2}, wherein the first user-specific coefficient comprises a sum of a user-specific system parameter, c_{u,1,0}, and a user-specific channel parameter, ε_{u,1}; and
an Nᵤ-point discrete affine Fourier transform (318) characterized by the system parameter, c_{1,0}, and the second coefficient, c₂.

10. The device (110, 200, 700) according to claim 9, further configured to determine the user-specific channel parameter, ε_{u,1}, based on channel state information of user u.

11. The device (110, 200, 300, 500, 700) according claim 9, further configured to transmit the signal and transmit an indication of at least one of:
the first user-specific coefficient, c_{u,1},
the second user-specific coefficient, c_{u,2},
the user-specific system parameter, c_{u,1,0}, and
the user-specific channel parameter, ε_{u,1}.

12. The device (110, 200, 700) according to claim 7, wherein the channel parameter, ε₁, is equal to zero, or wherein the device is further configured to determine the channel parameter, ε₁, based on an aggregation of channel state information of the set of U users u∈{1, . . . , U}.

13. The device (110, 200, 300, 500, 700) according to claim 2, further configured to determine a length of the prefix or a length of the suffix as a function of the first coefficient, c₁, the second coefficient, c₂, and the channel state information.

14. The device (110, 200, 300, 500, 700) according to claim 1, further configured to transmit the signal and an indication of at least one of:
the first coefficient, c₁,
the system parameter, c_{1,0},
the channel parameter, ε₁, and
the second coefficient, c₂.

15. A device (130, 200, 400, 600, 800) for receiving a signal, the device configured to:
demodulate the signal, wherein the signal comprises a plurality of chirp signals, w[m,n], modulated based on a set of input symbols,
wherein the plurality of chirp signals, w[m, n], are based on a bivariate polynomial, p(m, n), of input symbol index m and chirp signal time index n, wherein the bivariate polynomial, p(m, n), comprises a first coefficient, c₁, of a quadratic term of the chirp signal time index n and a second coefficient, c₂, of a quadratic term of the input symbol index m, and wherein the first coefficient, c₁, comprises a sum of a system parameter, c_{1,0}, and a channel parameter, ε₁.

16. The device (130, 200, 400, 600, 800) according to claim 15, further configured to:
apply an N -point discrete affine Fourier transform (420) characterized by the first coefficient, c₁, and the second coefficient, c₂, to the signal, wherein the signal comprises U sets of Nᵤ modulated input symbols for a set of U users, where u∈{1, . . . , U}, wherein U≥1, wherein each of the U sets of Nᵤ input symbols is divided into Cᵤ symbol blocks, wherein Cᵤ≥1, and wherein N is a maximum number of the plurality of chirp signals, w[m, n];
eliminate a prefix and a suffix of at least one of the Cᵤ symbol blocks; and
apply an inverse precoder (440) for the at least one of the Cᵤ symbol blocks.

17. The device (130, 200, 600) according to claim 16, wherein the inverse precoder comprises an
$$\\ ⌈ \frac{{N}_{u}}{{C}_{u}} ⌉$$
-point discrete Fourier transform (442).

18. The device (130, 200, 800) according to claim 16, wherein Cᵤ=1 and wherein the inverse precoder comprises:
an Nᵤ-point inverse discrete affine Fourier transform (446) characterized by the system parameter, c_{1,0}, and the second coefficient, c₂; and
an Nᵤ-point discrete affine Fourier transform (448) characterized by a first user-specific coefficient, c_{u,1}, and a second user-specific coefficient, c_{u,2}, wherein the first user-specific coefficient comprises a sum of a user-specific system parameter, c_{u,1,0}, and a user-specific channel parameter, ε_{u,1}.

19. The device (130, 200, 400, 600, 800) according to claim 18, further configured to receive an indication of at least one of:
the first user-specific coefficient, c_{u,1},
the second user-specific coefficient, c_{u,2},
the user-specific system parameter, c_{u,1,0}, and
the user-specific channel parameter, ε_{u,1}.

20. A method (900) for generating a signal, the method comprising:
obtaining a set of input symbols; and
modulating a plurality of chirp signals, w[m, n], based on the set of input symbols, wherein the plurality of chirp signals, w[m, n], are based on a bivariate polynomial, p(m, n), of input symbol index m and chirp signal time index n, wherein the bivariate polynomial, p(m, n), comprises a first coefficient, c₁, of a quadratic term of the chirp signal time index n and a second coefficient, c₂, of a quadratic term of the input symbol index m, and wherein the first coefficient, c₁, comprises a sum of a system parameter, c_{1,0}, and a channel parameter, ε₁.
